(19) United States
(12) Patent Application Publication
(10) Pub. No.: US 2010/0074460 A1
(43) Pub. Date: Mar. 25, 2010

(54) SELF-STEERING DIRECTIONAL HEARING AID AND METHOD OF OPERATION THEREOF

(75) Inventor: Thomas L. Marzetta, Summit, NJ (US)

Correspondence Address: HITT GAINES, PC;ALCATEL-LUCENT, PO BOX 832570, RICHARDSON, TX, 75083, US

(73) Assignee: Lucent Technologies Inc., Murray Hill, NJ (US)

(21) Appl. No.: 12/238,346

(22) Filed: Sep. 25, 2008

(51) Int. Cl. H04R 25/00

(52) U.S. Cl. 381/313; 381/327

(57) ABSTRACT

A hearing aid and a method of enhancing sound. In one embodiment, the hearing aid includes: (1) a direction sensor configured to produce data for determining a direction in which attention of a user is directed, (2) microphones to provide output signals indicative of sound received at the user from a plurality of directions, (3) a speaker for converting an electrical signal into enhanced sound and (4) an acoustic processor configured to be coupled to the direction sensor, the microphones, and the speaker, the acoustic processor being configured to superpose the output signals based on the determined direction to yield an enhanced signal based on the received sound, the enhanced signal having a higher content of sound received from the direction than sound received at the user.

### TECHNICAL FIELD OF THE INVENTION

The invention is directed, in general, to hearing aids and, more specifically, to a self-steering directional hearing aid and a method of operating the same.

### BACKGROUND OF THE INVENTION

Hearing aids are relatively small electronic devices used by the hard-of-hearing to amplify surrounding sounds. By means of a hearing aid, a person is able to participate in conversations and enjoy receiving audible information. Thus a hearing aid may properly be thought of as more than just a medical device, but rather a social necessity.

All hearing aids have a microphone, an amplifier (typically with a filter) and a speaker (typically an earphone) They fall in two major categories: analog and digital. Analog hearing aids are older and employ analog filters to shape and improve the sound. Digital hearing aids are more recent devices and use more modern digital signal processing techniques to provide superior sound quality.

Hearing aids come in three different configurations: behind-the-ear (BTE), in-the-ear (ITE) and in-the-canal (ITC). BTE hearing aids are the oldest and least discreet. They wrap around the back of the ear and are quite noticeable. However, they are still in wide use because they do not require as much miniaturization and are therefore relatively inexpensive. Their size also allows them to accommodate larger and more powerful circuitry, enabling them to compensate for particularly severe hearing loss. ITE hearing aids fit wholly within the ear, but protrude from the canal and are thus still visible. While they are more expensive than BTE hearing aids, they are probably the most common configuration prescribed today. ITC hearing aids are the most highly miniaturized of the hearing aid configurations. They fit entirely within the auditory canal. They are the most discreet but also the most expensive. Since miniaturization is such an acute challenge with ITC hearing aids, all but the most recent models tend to be limited in terms of their ability to capture, filter and amplify sound.

Hearing aids work best in a quiet, acoustically “dead,” room with a single source of sound. However, this seldom reflects the real world. Far more often the hard-of-hearing find themselves in crowded, loud places, such as restaurants, stadiums, city sidewalks and automobiles, in which many sources of sound compete for attention and echoes abound. Although the human brain has an astonishing ability to discriminate among competing sources of sound, conventional hearing aids have had great difficulty doing so. Accordingly, the hard-of-hearing are left to deal with the cacophony their hearing aids produce.

### SUMMARY OF THE INVENTION

To address the above-discussed deficiencies of the prior art, one aspect of the invention provides a hearing aid. In one embodiment, the hearing aid includes: (1) a direction sensor configured to produce data for determining a direction in which attention of a user is directed, (2) microphones to provide output signals indicative of sound received at the user from a plurality of directions, (3) a speaker for converting an electrical signal into enhanced sound and (4) an acoustic processor configured to be coupled to the direction sensor, the microphones, and the speaker, the acoustic processor being configured to superpose the output signals based on the determined direction to yield an enhanced signal based on the received sound, the enhanced signal having a higher content of sound received from the direction than sound received at the user.

In another embodiment, the hearing aid includes: (1) an eyeglass frame, (2) a direction sensor on the eyeglass frame and configured to provide data indicative of a direction of visual attention of a user wearing the eyeglass frame, (3) microphones arranged in an array and configured to provide output signals indicative of sound received at the user from a plurality of directions, (4) an earphone to convert an enhanced signal into enhanced sound and (5) an acoustic processor configured to be coupled to the direction sensor, the earphone and the microphones, the processor being configured to superpose the output signals to produce the enhanced signal, the enhanced sound having a increased content of sound incident on the user from the direction of visual attention than the sound received at the user.

Another aspect of the invention provides a method of enhancing sound. In one embodiment, the method includes: (1) determining a direction of visual attention of a user, (2) providing output signals indicative of sound received from a plurality of directions at the user by microphones having fixed positions relative to one another and relative to the user, (3) superposing the output signals based on the direction of visual attention to yield an enhanced sound signal and (4) converting the enhanced sound signal into enhanced sound, the enhanced sound having a increased content of sound from the determined direction than the sound received at the user.

### BRIEF DESCRIPTION OF THE DRAWINGS

For a more complete understanding of the invention, reference is now made to the following descriptions taken in conjunction with the accompanying drawings, in which:

FIG. 1A is a highly schematic view of a user indicating various locations thereon at which various components of a hearing aid constructed according to the principles of the invention may be located;

FIG. 1B is a high-level block diagram of one embodiment of a hearing aid constructed according to the principles of the invention;

FIG. 2 schematically illustrates a relationship between the user of FIG. 1A, a point of gaze and an array of microphones;

FIG. 3A schematically illustrates one embodiment of a non-contact optical eye tracker that may constitute the direction sensor of the hearing aid of FIG. 1A;

FIG. 3B schematically illustrates one embodiment of a hearing aid having an accelerometer and constructed according to the principles of the invention;

FIG. 4 schematically illustrates a substantially planar two-dimensional array of microphones;

FIG. 5 illustrates three output signals of three corresponding microphones and integer multiple delays thereof and delay-and-sum beamforming performed with respect thereto; and

FIG. 6 illustrates a flow diagram of one embodiment of a method of enhancing sound carried out according to the principles of the invention.

### DETAILED DESCRIPTION

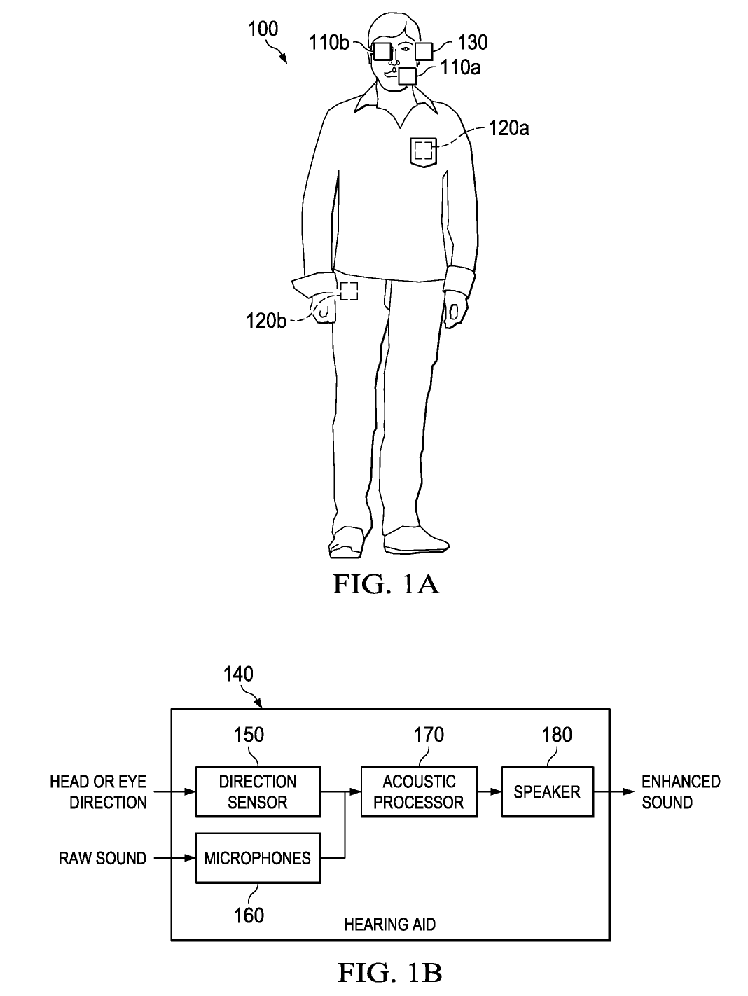

FIG. 1A is a highly schematic view of a user 100 indicating various locations thereon at which various components of a hearing aid constructed according to the principles of the invention may be located. In general, such a hearing aid includes a direction sensor, microphones, an acoustic processor and one or more speakers.

In one embodiment, the direction sensor is associated with any portion of the head of the user 100 as a block 110a indicates. This allows the direction sensor to produce a head position signal that is based on the direction in which the head of the user 100 is pointing. In a more specific embodiment, the direction sensor is proximate one or both eyes of the user 100 as a block 110b indicates. This allows the direction sensor to produce an eye position signal based on the direction of the gaze of the user 100. Alternative embodiments locate the direction sensor in other places that still allow the direction sensor to produce a signal based on the direction in which the head or one or both eyes of the user 100 are pointed.

In one embodiment, the microphones are located within a compartment that is sized such that it can be placed in a shirt pocket of the user 100 as a block 120a indicates. In an alternative embodiment, the microphones are located within a compartment that is sized such that it can be placed in a pants pocket of the user 100 as a block 120b indicates. In another alternative embodiment, the microphones are located proximate the direction sensor, indicated by the block 110a or the block 110b. The aforementioned embodiments are particularly suitable for microphones that are arranged in an array. However, the microphones need not be so arranged. Therefore, in yet another alternative embodiment, the microphones are distributed between or among two or more locations on the user 100, including but not limited to those indicated by the blocks 110a, 110b, 120a, 120b. In still another alternative embodiment, one or more of the microphones are not located on the user 100, but rather around the user 100, perhaps in fixed locations in a room in which the user 100 is located.

In one embodiment, the acoustic processor is located within a compartment that is sized such that it can be placed in a shirt pocket of the user 100 as the block 120a indicates. In an alternative embodiment, the acoustic processor is located within a compartment that is sized such that it can be placed in a pants pocket of the user 100 as the block 120b indicates. In another alternative embodiment, the acoustic processor is located proximate the direction sensor, indicated by the block 110a or the block 110b. In yet another alternative embodiment, components of the acoustic processor are distributed between or among two or more locations on the user 100, including but not limited to those indicated by the blocks 110a, 110b, 120a, 120b. In still other embodiments, the acoustic processor is co-located with the direction sensor or one or more of the microphones.

In one embodiment, the one or more speakers are placed proximate one or both ears of the user 100 as a block 130 indicates. In this embodiment, the speaker may be an earphone. In an alternative embodiment, the speaker is not an earphone and is placed within a compartment located elsewhere on the body of the user 100. It is important, however, that the user 100 receive the acoustic output of the speaker. Thus, whether by proximity to one or both ears of the user 100, by bone conduction or by sheer output volume, the speaker should communicate with one or both ears. In one embodiment, the same signal is provided to each one of multiple speakers. In another embodiment, different signals are provided to each of multiple speakers based on hearing characteristics of associated ears. In yet another embodiment, different signals are provided to each of multiple speakers to yield a stereophonic effect.

FIG. 1B is a high-level block diagram of one embodiment of a hearing aid 140 constructed according to the principles of the invention. The hearing aid 140 includes a direction sensor 150. The direction sensor 150 is configured to determine a direction in which a user's attention is directed. The direction sensor 150 may therefore receive an indication of head direction, an indication of eye direction, or both, as FIG. 1B indicates. The hearing aid 140 includes microphones 160 having known positions relative to one another. The microphones 160 are configured to provide output signals based on received acoustic signals, called “raw sound” in FIG. 1B. The hearing aid 140 includes an acoustic processor 170. The acoustic processor 170 is coupled by wire or wirelessly to the direction sensor 150 and the microphones 160. The acoustic processor 170 is configured to superpose the output signals received from the microphones 160 based on the direction received from the direction sensor 150 to yield an enhanced sound signal. The hearing aid 140 includes a speaker 180. The speaker 180 is coupled by wire or wirelessly to the acoustic processor 170. The speaker 180 is configured to convert the enhanced sound signal into enhanced sound, as FIG. 1B indicates.

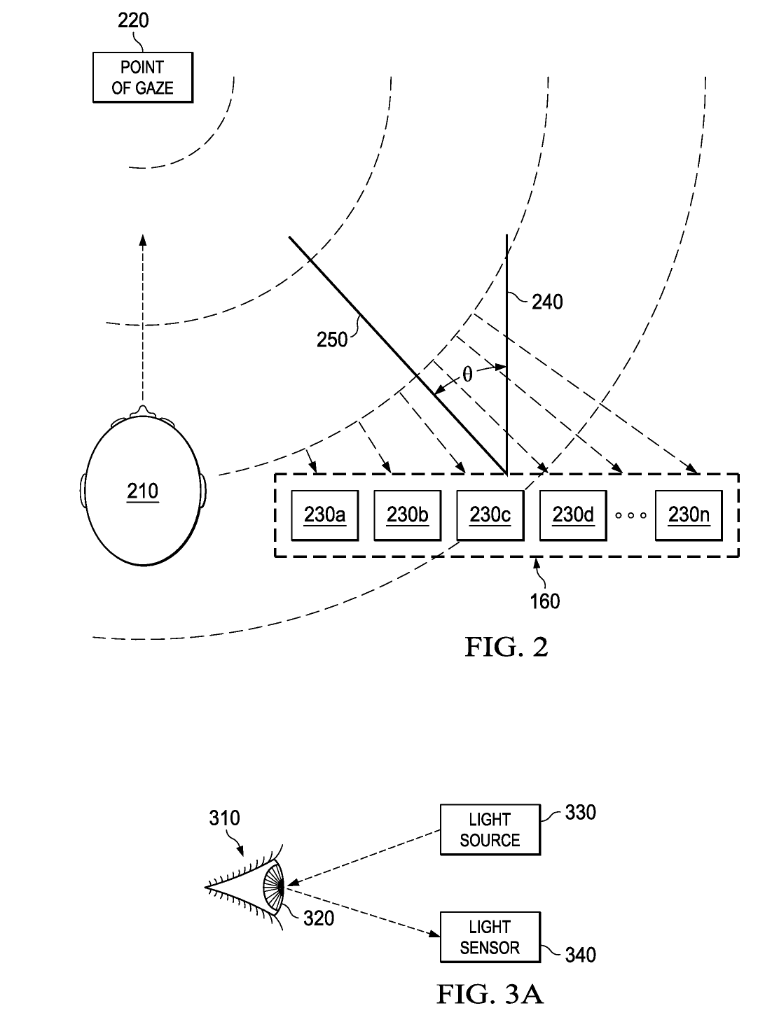

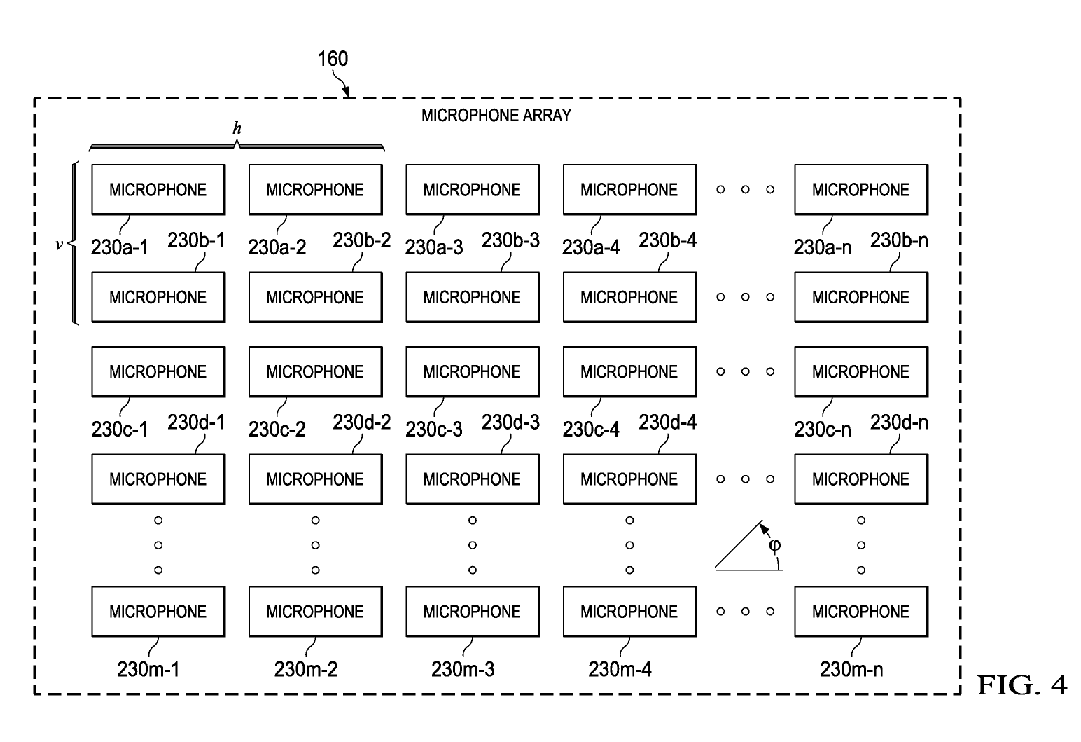

FIG. 2 schematically illustrates a relationship between the user 100 of FIG. 1A, a point of gaze 220 and an array of microphones 160, which FIG. 2 illustrates as being a periodic array (one in which a substantially constant pitch separates the microphones 160). FIG. 2 shows a topside view of a head 210 of the user 100 of FIG. 1A. The head 210 has unreferenced eyes and ears. An unreferenced arrow leads from the head 210 toward the point of gaze 220. The point of gaze 220 may, for example, be a person with whom the user is engaged in a conversation, a television set that the user is watching or any other subject of the user's attention. Unreferenced arcs emanate from the point of gaze 220 signifying wavefronts of acoustic energy (sounds) emanating therefrom. The acoustic energy, together with acoustic energy from other, extraneous sources, impinges upon the array of microphones 160. The array of microphones 160 includes microphones 230a, 230b, 230c, 230d, 230n. The array may be a one-dimensional (substantially linear) array, a two-dimensional (substantially planar) array, a three-dimensional (volume) array or of any other configuration. Unreferenced broken-line arrows indicate the impingement of acoustic energy from the point of gaze 220 upon the microphones 230a, 230b, 230c, 230d, . . . , 230n. Angles θ and φ (see FIG. 4) separate a line 240 normal to the line or plane of the array of microphones 230a, 230b, 230c, 230d, . . . , 230n and a line 250 indicating the direction between the point of gaze 220 and the array of microphones 230a, 230b, 230c, 230d, . . . , 230n. It is assumed that the orientation of the array of microphones 230a, 230b, 230c, 230d, . . . , 230n is known (perhaps by fixing them with respect to the direction sensor 150 of FIG. 1B). The direction sensor 150 of FIG. 1B determines the direction of the line 250. The line 250 is then known. Thus, the angles θ and φ may be determined. As will be shown, output signals from the microphones 230a, 230b, 230c, 230d, . . . , 230n may be superposed based on the angles θ and 100 to yield enhanced sound.

In an alternative embodiment, the orientation of the array of microphones 230a, 230b, 230c, 230d, . . . , 230n is determined with an auxiliary orientation sensor (not shown), which may take the form of a position sensor, an accelerometer or another conventional or later-discovered orientation-sensing mechanism.

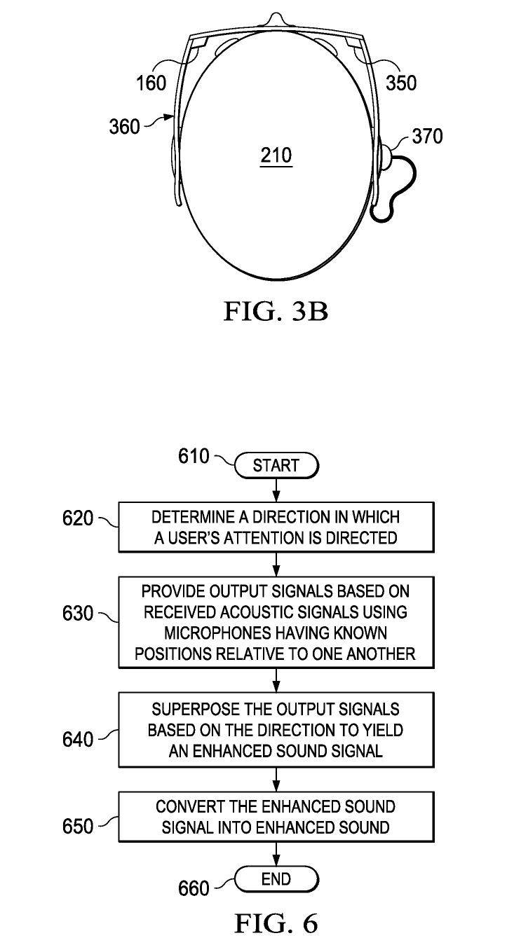

FIG. 3A schematically illustrates one embodiment of a non-contact optical eye tracker that may constitute the direction sensor 150 of the hearing aid of FIG. 1A. The eye tracker takes advantage of corneal reflection that occurs with respect to a cornea 320 of an eye 310. A light source 330, which may be a low-power laser, produces light that reflects off the cornea 320 and impinges on a light sensor 340 at a location that is a function of the gaze (angular position) of the eye 310. The light sensor 340, which may be an array of charge-coupled devices (CCD), produces an output signal that is a function of the gaze. Of course, other eye-tracking technologies exist and fall within the broad scope of the invention. Such technologies include contact technologies, including those that employ a special contact lens with an embedded mirror or magnetic field sensor or other noncontact technologies, including those that measure electrical potentials with contact electrodes placed near the eyes, the most common of which is the electro-oculogram (EOG).

FIG. 3B schematically illustrates one embodiment of a hearing aid having an accelerometer 350 and constructed according to the principles of the invention. Head position detection can be used in lieu of or in addition to eye tracking. Head position tracking may be carried out with, for example, a conventional or later-developed angular position sensor or accelerometer. In FIG. 3B, the accelerometer 350 is incorporated in, or coupled to, eyeglass frame 360. The microphones 160 may likewise be incorporated in, or coupled to, the eyeglass frame 360. Conductors (not shown) embedded in or on the eyeglass frame 360 couple the accelerometer 350 to the microphones 160. Though not shown in FIG. 3B, the acoustic processor 170 of FIG. 1 may likewise be incorporated in, or coupled to, the eyeglass frame 360 and coupled by wire to the accelerometer 350 and the microphones 160. In the embodiment of FIG. 3B, a wire leads from the eyeglass frame 360 to a speaker 370, which may be an earphone, located proximate one or both ears, allowing the speaker 370 to convert an enhanced sound signal produced by the acoustic processor into enhanced sound and delivered to the user's ear. In an alternative embodiment, the speaker 370 is wirelessly coupled to the acoustic processor.

With reference to FIG. 3B, one embodiment of a hearing aid constructed according to the principles of the invention includes: an eyeglass frame, a direction sensor coupled to the eyeglass frame and configured to determine a direction in which a user's attention is directed, microphones coupled to the eyeglass frame, arranged in an (e.g., periodic) array and configured to provide output signals based on received acoustic signals, an acoustic processor, coupled to the eyeglass frame, the direction sensor and the microphones and configured to superpose the output signals based on the direction to yield an enhanced sound signal and an earphone coupled to the eyeglass frame and configured to convert the enhanced sound signal into enhanced sound.

FIG. 4 schematically illustrates a substantially planar, regular two-dimensional m-by-n array of microphones 160. Individual microphones in the array are designated 230a-1, 230m-n and are separated on-center by a horizontal pitch h and a vertical pitch v. In the embodiment of FIG. 4, h and v are not equal. In an alternative embodiment, h=v. Assuming acoustic energy from various sources, including the point of gaze 220 of FIG. 2, is impinging on the array of microphones 160, one embodiment of a technique for superposing the output signals to enhance the acoustic energy emanating from the point of gaze 220 relative to that emanating from other sources will now be described. The technique will be described with reference to three output signals produced by the microphones 230a-1, 230a-2, 230a-3, with the understanding that any number of output signals may be superposed using the technique.

In the embodiment of FIG. 4, the relative positions of the microphones 230a-1, . . . , 230m-n are known, because they are separated on-center by known horizontal and vertical pitches. In an alternative embodiment, the relative positions of microphones may be determined by causing acoustic energy to emanate from a known location or determining the location of emanating acoustic energy (perhaps with a camera), capturing the acoustic energy with the microphones and determining the amount by which the acoustic energy is delayed with respect to each microphone (perhaps by correlating lip movements with captured sounds). Correct relative delays may thus be determined. This embodiment is particularly advantageous when microphone positions are aperiodic (i.e., irregular), arbitrary, changing or unknown. In additional embodiments, wireless microphones may be employed in lieu of, or in addition to, the microphones 230a-1, . . . , 230m-n.

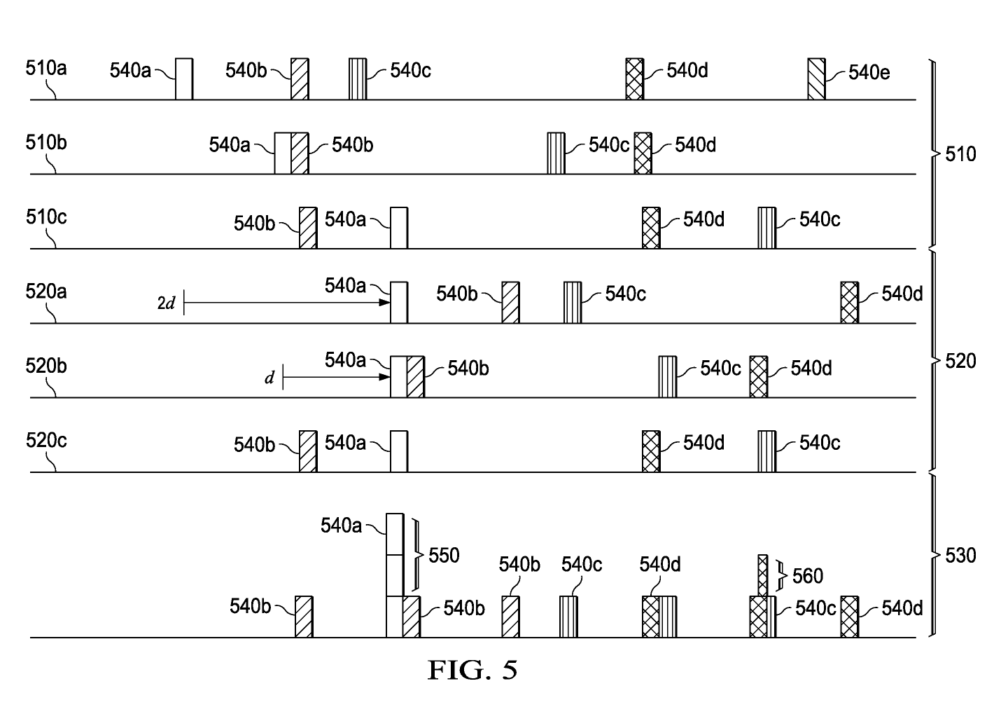

FIG. 5 illustrates three output signals of three corresponding microphones 230a-1, 230a-2, 230a-3 and integer multiple delays thereof and delay-and-sum beamforming performed with respect thereto. For ease of presentation, only particular transients in the output signals are shown, and they are idealized into rectangles of fixed width and unit height. The three output signals are grouped. The signals as they are received from the microphones 230a-1, 230a-2, 230a-3 are contained in a group 510 and designated 510a, 510b, 510c. The signals after they are time-delayed but before superposition are contained in a group 520 and designated 520a, 520b, 520c. The signals after they are superposed to yield a single enhanced sound signal are designated 530.

The signal 510a contains a transient 540a representing acoustic energy received from a first source, a transient 540b representing acoustic energy received from a second source, a transient 540c representing acoustic energy received from a third source, a transient 540d representing acoustic energy received from a fourth source and a transient 540e representing acoustic energy received from a fifth source.

The signal 510b also contains transients representing acoustic energy emanating from the first, second, third, fourth and fifth sources (the last of which occurring too late to fall within the temporal scope of FIG. 5). Likewise, the signal 510c contains transients representing acoustic energy emanating from the first, second, third, fourth and fifth sources (again, the last falling outside of FIG. 5).

Although FIG. 5 does not show this, it can be seen that, for example, a constant delay separates the transients 540a occurring in the first, second and third output signals 510a, 510b, 510c. Likewise, a different, but still constant, delay separates the transients 540b occurring in the first, second and third output signals 510a, 510b, 510c. The same is true for the remaining transients 540c, 540d, 540e. Referring back to FIG. 2, this is a consequence of the fact that acoustic energy from different sources impinges upon the microphones at different but related times that is a function of the direction from which the acoustic energy is received.

One embodiment of the acoustic processor takes advantage of this phenomenon by delaying output signals relative to one another such that transients emanating from a particular source constructively reinforce with one another to yield a substantially higher (enhanced) transient. The delay is based on the output signal received from the detection sensor, namely an indication of the angle θ, upon which the delay is based.

The following equation relates the delay to the horizontal and vertical pitches and of the microphone relay:

$$d = \frac{\sqrt{{( h sin θcos ϕ )}^{2} + {( v sin θsin ϕ )}^{2}}}{{V}_{s}}$$

where d is the delay, integer multiples of which the acoustic processor applies to the output signal of each microphone in the array, φ is the angle between the projection of the line 250 of FIG. 2 onto the plane of the array (e.g., a spherical coordinate representation) and an axis of the array, and Vₛ is the nominal speed of sound in air. Either h or v may be regarded as being zero in the case of a one-dimensional (linear) microphone array.

In FIG. 5, the transients 540a occurring in the first, second and third output signals 510a, 510b, 510c are assumed to represent acoustic energy emanating from the point of gaze (220 of FIG. 2), and all other transients are assumed to represent acoustic energy emanating from other, extraneous sources. Thus, the appropriate thing to do is to delay the output signals 510a, 510b, 510c such that the transients 540a constructively reinforce, and beam forming is achieved. Thus, the group 520 shows the output signal 520a delayed by a time 2d relative to its counterpart in the group 510, and the group 520 shows the output signal 520b delayed by a time d relative to its counterpart in the group 510.

Following superposition, the transition 540a in the enhanced sound signal 530 is (ideally) three units high and therefore significantly enhanced relative to other transients 540b, 540c, 540d. A bracket 550 indicates the margin of enhancement. It should be noted that while some incidental enhancement of other transients may occur (viz., the bracket 560), the incidental enhancement is likely not to be as significant in either amplitude or duration.

The example of FIG. 5 may be adapted to a hearing aid in which its microphones are not arranged in an array having a regular pitch; d may be different for each output signal. It is also anticipated that some embodiments of the hearing aid may need some calibration to adapt them to particular users. This calibration may involve adjusting the eye tracker if the hearing aid employs one, adjusting the volume of the speaker, and determining the positions of the microphones relative to one another if they are not arranged into an array having a regular pitch or pitches.

The example of FIG. 5 assumes that the point of gaze is sufficiently distant from the array of microphones such that it lies in the “Fraunhofer zone” of the array and therefore wavefronts of acoustic energy emanating therefrom may be regarded as essentially flat. If, however, the point of gaze lies in the “Fresnel zone” of the array, the wavefronts of the acoustic energy emanating therefrom will exhibit appreciable curvature. For this reason, the time delays that should be applied to the microphones will not be multiples of a single delay d. Also, if point of gaze lies in the “Fresnel zone,” the position of the microphone array relative to the user may need to be known. If the hearing aid is embodied in eyeglass frames, the position will be known and fixed. Of course, other mechanisms, such as an auxiliary orientation sensor, could be used.

An alternative embodiment to that shown in FIG. 5 employs filter, delay and sum processing instead of delay-and-sum beamforming. In filter, delay and sum processing, a filter is applied to each microphone such that the sums of the frequency responses of the filters add up to unity in the desired direction of focus. Subject to this constraint, the filters are chosen to try to reject every other sound.

FIG. 6 illustrates a flow diagram of one embodiment of a method of enhancing sound carried out according to the principles of the invention. The method begins in a start step 610. In a step 620, a direction in which a user's attention is directed is determined. In a step 630, output signals based on received acoustic signals are provided using microphones having known positions relative to one another. In a step 640, the output signals are superposed based on the direction to yield an enhanced sound signal. In a step 650, the enhanced sound signal is converted into enhanced sound. The method ends in an end step 660.

Those skilled in the art to which the invention relates will appreciate that other and further additions, deletions, substitutions and modifications may be made to the described embodiments without departing from the scope of the invention.

What is claimed is:

1. A hearing aid, comprising:
a direction sensor configured to produce data for determining a direction in which attention of a user is directed;
microphones to provide output signals indicative of sound received at the user from a plurality of directions;
a speaker for converting an electrical signal into enhanced sound; and
an acoustic processor configured to be coupled to said direction sensor, said microphones, and said speaker, the acoustic processor being configured to superpose said output signals based on said determined direction to yield an enhanced signal based on said received sound, the enhanced signal having a higher content of sound received from the direction than sound received at the user.

2. The hearing aid as recited in claim 1 wherein said direction sensor is an eye tracker configured to provide an eye position signal indicative of a direction of a gaze of the user.

3. The hearing aid as recited in claim 1 wherein said direction sensor comprises an accelerometer configured to provide a signal indicative of a movement of a head of the user.

4. The hearing aid as recited in claim 1 wherein said microphones are arranged in a substantially linear one-dimensional array.

5. The hearing aid as recited in claim 1 wherein said microphones are arranged in a substantially planar two-dimensional array.

6. The hearing aid as recited in claim 1 wherein said acoustic processor is configured to apply a integer multiple of a delay to each of said output signals, said delay being based on an angle between a direction of gaze and a line normal to said microphones.

7. The hearing aid as recited in claim 1 wherein said direction sensor is incorporated into an eyeglass frame.

8. The hearing aid as recited in claim 7 wherein said microphones and said acoustic processor are further incorporated into said eyeglass frame.

9. The hearing aid as recited in claim 1 wherein said microphones and said acoustic processor are located within a compartment.

10. The hearing aid as recited in claim 1 wherein said speaker is an earphone wirelessly coupled to said acoustic processor.

11. A method of enhancing sound, comprising:
determining a direction of visual attention of a user;
providing output signals indicative of sound received from a plurality of directions at the user by microphones having fixed positions relative to one another and relative to the user;
superposing said output signals based on said direction of visual attention to yield an enhanced sound signal; and
converting said enhanced sound signal into enhanced sound, the enhanced sound having a increased content of sound from the determined direction than the sound received at the user.

12. The method as recited in claim 11 wherein said determining comprises providing an eye position signal based on a direction of a gaze of the user.

13. The method as recited in claim 11 wherein said determining comprises providing a head position signal based on an orientation or a motion of a head of the user.

14. The method as recited in claim 11 wherein said microphones are arranged in a substantially linear one-dimensional array.

15. The method as recited in claim 11 wherein said microphones are arranged in a substantially planar two-dimensional array.

16. The method as recited in claim 11 wherein said superposing comprises applying integer multiples of a delay to said output signals, said delay based on an angle between a direction of gaze by the user and a line normal to said microphones.

17. A hearing aid, comprising:
an eyeglass frame;
a direction sensor on said eyeglass frame and configured to provide data indicative of a direction of visual attention of a user wearing the eyeglass frame;
microphones arranged in an array and configured to provide output signals indicative of sound received at the user from a plurality of directions;
an earphone to convert an enhanced signal into enhanced sound; and
an acoustic processor configured to be coupled to said direction sensor, said earphone and said microphones, the processor being configured to superpose said output signals to produce the enhanced signal, said enhanced sound having a increased content of sound incident on the user from the direction of visual attention than the sound received at the user.

18. The hearing aid as recited in claim 17 wherein said direction sensor is an eye tracker configured to provide an eye position signal based on a direction of a gaze of the user.

19. The hearing aid as recited in claim 17 wherein said direction sensor comprises an accelerometer configured to provide data indicative of a head motion of the user.

20. The hearing aid as recited in claim 17 wherein said array is regular and said earphone is coupled to said acoustic processor via a wire.
